(19) United States
(12) Patent Application Publication
(10) Pub. No.: US 2007/0226400 A1
(43) Pub. Date: Sep. 27, 2007

(54) INFORMATION PROCESSING APPARATUS AND METHOD OF USING OTP MEMORY

(75) Inventor: Fumiaki Tsukazaki, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MegaChips LSI Solutions Inc., Osaka-shi (JP)

(21) Appl. No.: 11/685,400

(22) Filed: Mar. 13, 2007

(30) Foreign Application Priority Data
Mar. 24, 2006 (JP) 2006-082070

(51) Int. Cl. G06F 12/00; G06F 13/00

(52) U.S. Cl. 711/102; 711/154

(57) ABSTRACT

In an OTP memory, initially, a file A is recorded. When modification of the file A is needed, a modification file B is additionally written into the OTP memory. Storage information on the modification file B is also additionally written into a FAT area and a directory entry. When an application program issues a read request for the file A, a file system refers to the FAT area and the directory entry to recognize the existence of the modification file B and reads the file A and the modification file B out from a data area. Then, the file system modifies the file A on the basis of the modification file B and stores a modified file into a RAM. The application program accesses the file which is stored in the RAM.

### BACKGROUND OF THE INVENTION

1. Field of the Invention

The present invention relates to a technique to use an OTP memory.

2. Description of the Background Art

As a medium for storing control programs, setup data and the like for electronic equipments therein, mask ROMs are used. Further, mask ROMs in which game programs are stored are used for game cartridges to be mounted into game devices. Programs or data are recorded in the mask ROMs in plants, and the mask ROMs are supplied to users. Though the mask ROM allows an information processing apparatus only to read out data therefrom, it has the advantage of lower manufacturing cost as compared with rewritable memories. The mask ROM also has the advantage that data is not erased by accident. For these reasons, the mask ROMs are conventionally used for electronic equipments with built-in systems and game cartridges.

Further, there is a type of memories which allows users to write data into a memory area only once. In general, this type is termed “OTP (One Time Programmable) memory”. The OTP memory also has a characteristic feature that programs and data stored therein are not erased, like those in the mask ROM. Recently, high-capacity and low-price OTP memories can be manufactured, and this produces an advantage of lower cost as compared with rewritable flash memories. Further, as compared with the mask ROMs, providing programs by the OTP memories advantageously ensures shorter TAT (turn-around time). From such a background, recently, OTP memories, instead of mask ROMs, have been used to store programs or data therein, to provide the programs or data to users.

As discussed above, by using mask ROMs to provide data, built-in systems and game cartridges can be supplied to users at low cost. This method, however, has the disadvantage that the programs or data stored in the mask ROMs can not be modified. Therefore, the programs to be stored in mask ROMs should be essentially tested many times lest these programs need modification. It is impossible, however, to completely remove bugs, and when some bug is actually found, the mask ROM itself has to be changed.

The above method of providing programs, which uses mask ROMs, has such a problem, and on the other hand, with complication of programs, there are more requests to allow modification of some problems and addition of functions for products after their release.

Though there are some techniques to modify programs in mask ROMs, these have high hurdles of needing a special hardware, requiring the knowledge of assembler language program and the like. Japanese Patent Application Laid Open Gazette No. 3-186927 shows a technique that an EEPROM (Electrically Erasable and Programmable ROM), besides the mask ROM, is used to store a modification module for a program code and a modification address for the program therein. When a program counter coincides with the modification address, the modification module stored in the EEPROM is executed. This method needs a rewritable memory to store the modification module therein besides the mask ROM. Further, in this method, since the program counter is operated, it is possible to modify the program code but impossible to modify data.

Japanese Patent Application Laid Open Gazette No. 2001-117766 also shows a technique which uses a flash memory to store a replacement module therein, besides the mask ROM. A CPU executes a program stored in the mask ROM by bypassing a module which is found to have a bug and reading out the replacement module stored in the flash memory. This method also additionally needs the flash memory to store the replacement module therein and causes an increase in cost. Further, this method causes an increase in components of the apparatus. Furthermore, regardless of whether there is a bug or not, it is necessary to mount an extra flash memory in advance in a chip of any built-in system or any game cartridge.

### SUMMARY OF THE INVENTION

The present invention is intended for an information processing apparatus using an OTP memory. According to the present invention, the information processing apparatus comprises a control part for executing a program and a file system, and the OTP memory comprises a data memory area in which the substance of data is stored and a file management information memory area in which storage information on a file stored in the data memory area is recorded, and in the information processing apparatus, after a first file is recorded in the data memory area and storage information on the first file is recorded in the file management information memory area, when modification of the first file is needed, a second file in which modification information on the first file is recorded is additionally written into the data memory area and storage information on the second file is additionally written into the file management information memory area, and the file system comprises modification means which reads out the first file and the second file by referring to the file management information memory area when the program issues an access request for the first file, for modifying the first file on the basis of the second file, and the program accesses a file modified by the file system.

With the information processing apparatus of the present invention, after a program or data is stored in the OTP memory in which data can be written only once and the OTP memory is supplied, it is possible to modify or improve the program or data.

Further, since the second file is additionally written into the memory area of the OTP memory, it is not necessary to provide another memory for storing the modification data therein. It is therefore possible to modify programs or data without causing increases in components of an apparatus and cost.

Furthermore, the information processing apparatus of the present invention uses the file system, instead of a special hardware, to modify the first file, and this suppresses a development cost. Since this is not a method of operating a program counter, it is possible to modify or improve not only programs but also data.

Moreover, programs can access the first file without being conscious of the existence of the second file, and this prevents complication in development of programs.

It is an object of the present invention to provide a technique to modify programs or data stored in a non-rewritable memory without causing a problem of increases in cost and components of an apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an information processing apparatus in accordance with preferred embodiments of the present invention;

FIG. 2 is a view showing a storage image of a modification file in an OTP memory in accordance with a first preferred embodiment;

FIG. 3 is a view showing a storage image of files to be modified;

FIG. 4 is a view showing a storage image of the modification file;

FIG. 5 is an image view showing application procedures of a patch;

FIG. 6 is a flowchart showing an application process of the patch;

FIG. 7 is a view showing a storage image of the modification file in an OTP memory in accordance with a second preferred embodiment; and

FIG. 8 is a view showing a storage image of the modification file in an OTP memory in accordance with a third preferred embodiment.

### DESCRIPTION OF THE PREFERRED EMBODIMENTS

### The First Preferred Embodiment

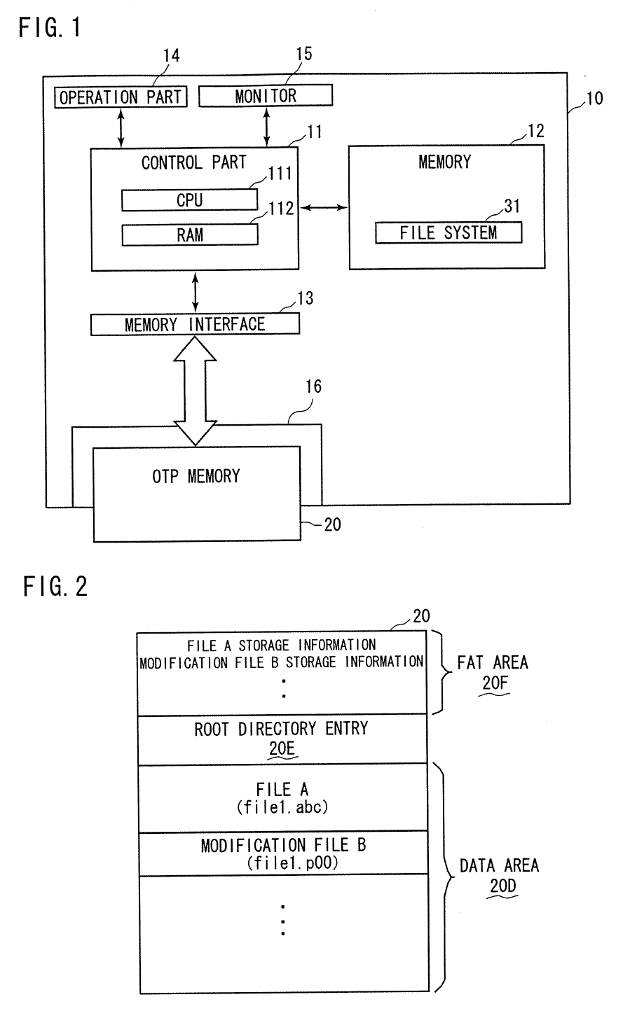

Discussion will be made below on the preferred embodiments of the present invention, with reference to figures. FIG. 1 is a block diagram showing an information processing apparatus 10 in accordance with the preferred embodiments of the present invention. The information processing apparatus 10 comprises a control part 11, a memory 12, a memory interface 13, an operation part 14, a monitor 15 and a memory slot 16. The control part 11 comprises a CPU 111 and a RAM 112 and executes a program to perform a general control on the information processing apparatus 10. The memory 12 is, e.g., a flash memory, in which a file system 31, other program or data is stored.

In the memory slot 16, an OTP (One Time Programmable) memory 20 is mounted. The control part 11 accesses the OTP memory 20 through the memory interface 13. Unlike a mask ROM in which data is stored through a manufacturing process in advance, the OTP memory is a PROM (Programmable Read Only Memory) in which data can be electrically written by users. In each memory area of the OTP memory, however, data can be written only once. The OTP memory 20 of the present preferred embodiment is an OTP memory which enables additional writing. Specifically, users can write data into a memory area of the OTP memory 20 only once but can additionally write data into a space (empty) area. In other words, programs or data written in the OTP memory 20 can not be modified or erased but other programs or data can be additionally written into an empty area.

In the first preferred embodiment, the memory areas of the OTP memory 20 are controlled by the file system 31. The file system 31 of the first preferred embodiment uses a FAT (File Allocation Tables) file system. FIG. 2 is a view showing a memory map of the OTP memory 20. The memory areas of the OTP memory 20 are divided into a FAT area 20F, a root directory entry 20E, a data area 20D and the like, for management. The data area 20D is an area to store the substance of a program file, a data file, or the like therein. In the root directory entry 20E, information on the filenames and the first cluster positions of files in a root directory is recorded. In the FAT area 20F, the cluster chain information on the program files or the data files stored in the data area 20D.

Though information on the filename and the first cluster position of a file stored in a subdirectory is recorded in a directory entry (not shown) in the data area 20D, description thereof will be omitted as its structure is the same as that of the root directory entry. Hereinafter, as appropriate, the root directory entry 20E and the directory entries of the subdirectories are generically termed “directory entries”.

Thus, storage information on files stored in the OTP memory 20 is recorded in the FAT area 20F and the directory entries. In other words, a file management information memory area of the present invention includes the FAT area 20F and the memory areas in the directory entries as well.

In the first preferred embodiment, a file A (file1.abc) is stored in the data area 20D of the OTP memory 20. The file A may be a program file or a data file. In other words, a file of this description refers to a general data structure in which a program code is stored and data needed for program execution is stored.

The information processing apparatus 10 is an apparatus to be operated by executing the program stored in the OTP memory 20. Specifically, the information processing apparatus 10 reads the program file or the data file out from the OTP memory 20 and performs procedures by using the hardware resources such as the CPU 111 and the RAM 112. If the information processing apparatus 10 is a game device, for example, the OTP memory 20 corresponds to a game cartridge. Specifically, the file A and other program files and data files are stored in the OTP memory 20 which is a game cartridge, to be supplied. By mounting the OTP memory 20 into the information processing apparatus 10 which is a game device, users can play games. In this case, the operation part 14 corresponds to a game controller and the monitor 15 displays pictures of the game.

The file A has a point to be modified. If the file A is a program file, for example, this may be a case where the program has a bug or where the program requires improvement. If the file A is a data file, this may be a case where setup information of the program should be modified.

Then, a modification file B (file1.p00) in which modification information for modifying the file A is recorded is additionally written into the data area 20D. In other words, the modification file B which is not recorded initially on shipment is additionally written at the point of time when the file A needs modification. For example, when a user takes an OTP memory 20 in which the file A is recorded to a shop, a recording apparatus (update apparatus) set in the shop additionally writes the modification file B into the data area 20D. In the FAT area 20F and the directory entry, storage information on the modification file B is additionally written. Specifically, information on the filename and the position of storage cluster of the modification file B is additionally written.

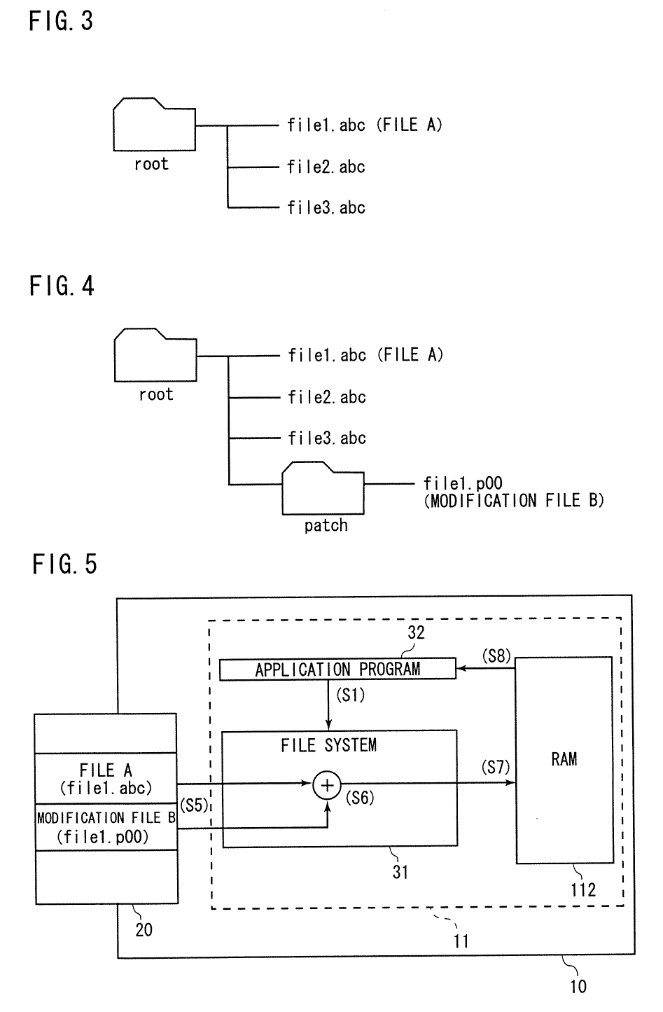

In other words, at the point of time when the OTP memory 20 is shipped out, the file A is recorded in the data area 20D and the storage information on the file A is recorded in the FAT area 20F and the directory entry. As shown in FIG. 3, for example, the file A (file1.abc) is recorded in the root directory. Then, when the file A needs modification, the modification file B is additionally written into the data area 20D and the storage information on the modification file B is additionally written into the FAT area 20F and directory entry. As shown in FIG. 4, for example, a “Patch” directory is made under the root directory and the modification file B is stored under the directory. Thus, in the first preferred embodiment, since the OTP memory 20 is a memory which enables additional writing, the modification file B and its storage information can be additionally written later.

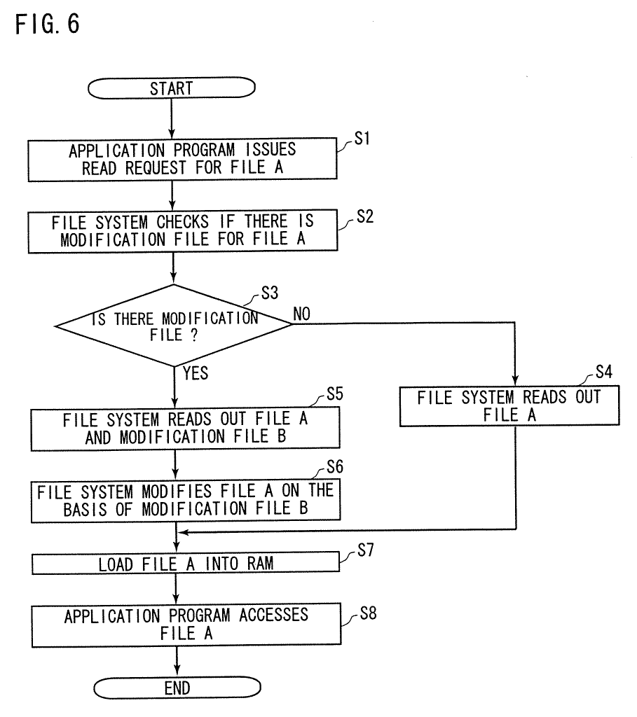

Next, with reference to FIGS. 5 and 6, discussion will be made on a method where the information processing apparatus 10 accesses the OTP memory 20 in which the file A and the modification file B are stored in the above-discussed form. FIG. 5 is an image view showing a method of reading a file, and FIG. 6 is a flowchart showing a process for reading a file. Reference sings such as S1, S5 and the like in FIG. 5 are given correspondingly to those in the flowchart of FIG. 6.

As shown in FIG. 5, in the information processing apparatus 10, the control part 11 executes the file system 31 and the application program 32. The application program 32 accesses the program file or the data file stored in the OTP memory 20 by using the file system 31. The application program 32 is a program read out from the OTP memory 20. Alternatively, the application program 32 may be a program read out from the memory 12. The application program 32 is a program to read the file A stored in the OTP memory 20 and use this file.

Discussion will be made, along the flowchart of FIG. 6. First, the application program 32 issues a read request for the file A (file1.abc) to the file system 31 (Step S1).

The file system 31 receives the read request and then checks if there is a modification file for the file A (Step S2). Since the file system 31 judges if there is a modification file, the filenames (except extensions) are made common in the first preferred embodiment. As shown in FIG. 4, the filename of the file A is “file1.abc” while the filename of the modification file B is “file1.p00”. Specifically, since the filenames except extensions are common, the file system 31 searches the directory entry for a file having the same filename as the file A, to recognize the existence of the modification file. In the exemplary case of the first preferred embodiment shown in FIG. 4, it is a rule that the modification file should be stored in the “Patch” directory. Therefore, the file system 31 searches the “Patch” directory for a file having the same filename (file1) except extension as the file A.

If there is no modification file (NO in Step S3), the file system 31 reads out the file A (Step S4). Since there is no modification file, the file system 31 reads out the file A as a normal operation.

If there is a modification file (YES in Step S3), the file system 31 reads out both the file A and the modification file B out from the OTP memory 20 (Step S5).

Next, the file system 31 modifies the file A on the basis of the modification information recorded in the modification file B (Step S6). Specifically, the file system 31 has a function to decode the content of the modification information recorded in the modification file and modify the file to be modified in accordance with the modification information. The format of the modification information recorded in the modification file is not particularly restricted. Formats that the file system 31 can respond to may be used. In general, differential information for the file to be modified may be used as the modification information.

Then, the file system 31 stores the modified file A into the RAM 112 (Step S7). Thus, the application program 32 can access the modified file A stored in the RAM 112 (Step S8).

Thus, by using the information processing apparatus 10 and the OTP memory 20 of the first preferred embodiment, it is possible to modify the file A stored in the OTP memory 20. Then, the modification file B in which the modification information is recorded is stored in a memory area of the same OTP memory 20 as the file A is stored. Therefore, it is not necessary to prepare another rewritable memory such as a flash memory in order to store the modification file. In other words, since it is not necessary to prepare another memory to store a modification file in a package for the information processing apparatus 10 and the OTP memory 20, it is possible to achieve modification of files without causing an increase in the number of component parts of the apparatus or the package or causing an increase in cost. Further, in the first preferred embodiment, it is possible to modify not only program files but also data files.

In order to apply a patch to a program stored in a mask ROM, a special knowledge of assembler language program and the like is conventionally needed. Though only modification methods which are narrowly applicable, where data can not be modified, have been conventionally used, it is possible, in the present invention, to easily apply a patch to program codes or data stored in released products.

Further, in the present invention, the modification file B can be written into any area only if it is an empty area of the data area 20D. Sometimes, the OTP memory 20 has an error (needs correction). A memory having an error includes ones having a 1-bit error, a plural-bit error (word error), a bit-line error, a block error or the like. There are two cases where recorded information has an error and where recorded information is correct but the information can not be read out normally. If the OTP memory 20 is a memory having such an error, sometimes, a defective area is replaced with another area, and in such a case, the file allocation in an initial state (on shipment), including the file A, is different individually. Also in such a case, the method of the present invention can be applied to a memory having some error since the modification file B may be stored in any one of empty areas.

Further, as a modification file, only differential information indicating the difference from the file to be modified has to be recorded. Therefore, it is possible to suppress the size of the modification file to the minimum.

Since the file system 31 modifies the file A from the file A and the modification file B and gives the modified file A to the application program 32, the application program 32 may issue a read request for the file A without being conscious of the existence of the modification file B, in the same manner as that before the modification. Therefore this prevents complication in development of the application programs 32.

The file system 31 may disclose the information on the modification file B to the application program 32. In the first preferred embodiment, however, the file system 31 does not disclose the information on the modification file B to the application program 32. In other words, the file system 31 does not provide the information on the modification file B to the application program 32 and hides the existence of the modification file B. Specifically, since the application program 32 can access the file A without being conscious of the existence of the modification file B, the file system 31 does not provide unnecessary information to prevent wrong access to a file.

In the first preferred embodiment, the filenames are made common in order to make the correspondence between a file and a modification file. Other than this method, the correspondence may be made by using the directory name. For example, a modification file for the file A (file1.abc) may be stored in a directory which is newly made and named “file1”, “file1_mod” or the like. The file system 31 searches the directory having a name associated with the filename of the file A, to recognize the existence of the modification file.

Alternatively, the correspondence with a file to be modified may be recorded in a head part of the modification file.

When a plurality of requests for modifications of the file A are issued, a plurality of modification files are made, and the order of application is specified in the filename of the modification file. In the exemplary case of FIG. 4, the filename of the modification file B is “file1.p00”. Then, when the file A that reflects the modification file B needs further modification, the filename of the modification file for this modification is determined as “file1.p01”. From then on, every time further modification is needed, the extension of the filename is incremented, as “p02”, “p03”, “p04” . . . . Then, the file system 31 reads out all these modification files (file1.p00, file1.p01, file1.p02 . . . ) when it reads out the file A, and uses these modification files in the order of extensions from file1.p00. With this operation, it is possible to modify the file A substantially without limitation and maintain consistency.

Further, if the correspondence with the file to be modified is recorded in the head part of the modification file as discussed above, information on the order of application should be also recorded in the head part. It thereby becomes possible to cope with a plurality of modifications.

### The Second Preferred Embodiment

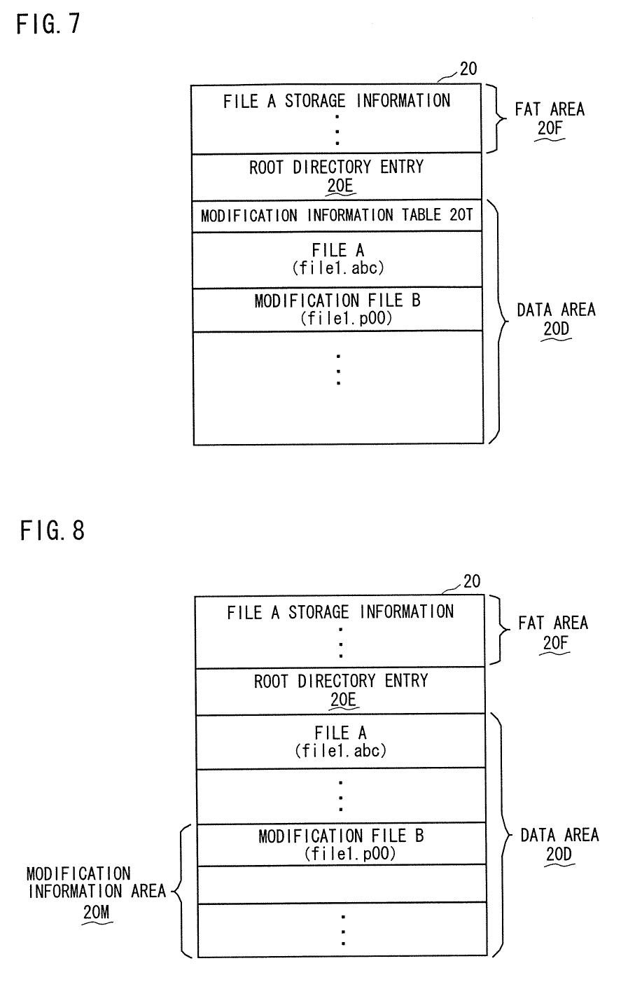

FIG. 7 is a view showing a manner of storing the modification file B in accordance with the second preferred embodiment. In the second preferred embodiment, the modification file B is additionally written into the data area 20D like in the first preferred embodiment. The storage information on the modification file B, however, is not additionally written into the FAT area 20F or the directory entry. The information on the modification file B is additionally written into a modification information table 20T recorded in the data area 20D.

The modification information table 20T has a table structure in which the storage information on the modification file can be additionally written. Therefore, the recording apparatus (update apparatus) for additionally writing the modification file B into the data area 20D also additionally writes the storage information on the modification file B into the modification information table 20T. The position of storage cluster in the modification information table 20T is determined in advance.

The method to allow the information processing apparatus 10 to access the file A is the same as that of the first preferred embodiment. The file system 31, however, refers to the modification information table 20T, instead of the FAT area 20F and the directory entry, to recognize the existence of the modification file B. The procedures and methods other than the above are the same as those in the first preferred embodiment.

Further, in the second preferred embodiment, since the storage information on the modification file B is not recorded in the FAT area 20F or the directory entry, it is automatically possible to hide the existence of the modification file B from the application program 32.

### The Third Preferred Embodiment

FIG. 8 is a view showing a manner of storing the modification file B in accordance with the third preferred embodiment. In the third preferred embodiment, the modification file B is additionally written into the data area 20D like in the first preferred embodiment. The modification file B, however, is not additionally written into a free area of the data area 20D but into a modification information area 20M which is reserved in the data area 20D. Further, the storage information on the modification file B is not additionally written into the FAT area 20F or the directory entry.

The method to allow the information processing apparatus 10 to access the file A is the same as that of the first preferred embodiment. The file system 31, however, searches the modification information area 20M, instead of referring to the FAT area 20F and the directory entry, to recognize the existence of the modification file B. Specifically, the file system 31 sequentially checks the filenames stored in the modification information area 20M, to retrieve, e.g., a file having the same name as the file A except the extension, like in the first preferred embodiment. The procedures and methods other than the above are the same as those in the first preferred embodiment.

Also in the third preferred embodiment, since the storage information on the modification file B is not recorded in the FAT area 20F or the directory entry, it is automatically possible to hide the existence of the modification file B from the application program 32.

<Variation>

In the above preferred embodiments, the modification file B is a file in which modification information (differential information) for modifying part of the file A is recorded. In the present invention, however, the file A can be replaced with the modification file B. In short, it is possible to perform replacement of the file A.

If so many modifications are needed, it is a complicated process to make a modification file B in which an enormous amount of modification information (differential information) are recorded and modify the file A on the basis of the modification information. It also takes a long time. Then, the modification file B is stored in the data area 20D as a replacement file for the file A.

If the modification file B is a replacement file, the information thereof should be recorded in the extension of the filename or the header information. For example, a rule may be made where a file of which extension is “p99” is a replacement file. In this case, the file system 31 does not modify the file A but reads out the modification file B instead of the file A. The application program 32 accesses the modification file B that is read out as the file A.

If the information processing apparatus 10 comprises a built-in OTP memory and the file system 31 is stored in the OTP memory inside the information processing apparatus 10, it is possible to modify this file system 31 in the same manner as the above method of the present invention. This allows the file system 31 to respond to various types of patch formats one after another.

While the invention has been shown and described in detail, the foregoing description is in all aspects illustrative and not restrictive. It is therefore understood that numerous modifications and variations can be devised without departing from the scope of the invention.

What is claimed is:

1. An information processing apparatus using an OTP (One Time Programmable) memory, comprising:
a control part for executing a program; and
a file system,
wherein said OTP memory comprises
a data memory area in which the substance of data is stored; and
a file management information memory area in which storage information on a file stored in said data memory area is recorded,
and wherein after a first file is recorded in said data memory area and storage information on said first file is recorded in said file management information memory area, when modification of said first file is needed, a second file in which modification information on said first file is recorded is additionally written into said data memory area and storage information on said second file is additionally written into said file management information memory area,
said file system comprises modification means which reads out said first file and said second file by referring to said file management information memory area when said program issues an access request for said first file, for modifying said first file on the basis of said second file, and
said program accesses a file modified by said file system.

2. The information processing apparatus according to claim 1, wherein
said file system does not disclose information on said second file to said program.

3. The information processing apparatus according to claim 1, wherein
if said second file is a replacement file for said first file, said modification means does not modify said first file but replaces said first file with said second file.

4. An information processing apparatus using an OTP (One Time Programmable) memory, comprising:
a control part for executing a program; and
a file system,
wherein said OTP memory comprises
a data memory area in which the substance of data is stored;
a file management information memory area in which storage information on a file stored in said data memory area is recorded; and
a modification information memory area which is a predetermined area in said data memory area, in which storage information on modification data is recorded,
and wherein after a first file is recorded in said data memory area and storage information on said first file is recorded in said file management information memory area, when modification of said first file is needed, a second file in which modification information on said first file is recorded is additionally written into said data memory area and storage information on said second file is additionally written into said modification information memory area,
said file system comprises modification means which reads out said first file and the second file by referring to said file management information memory area and said modification information memory area when said program issues an access request for said first file, for modifying said first file on the basis of said second file, and
said program accesses a file modified by said file system.

5. The information processing apparatus according to claim 4, wherein
said file system does not disclose information on said second file to said program.

6. The information processing apparatus according to claim 4, wherein
if said second file is a replacement file for said first file, said modification means does not modify said first file but replaces said first file with said second file.

7. An information processing apparatus using an OTP (One Time Programmable) memory, comprising:
a control part for executing a program; and
a file system,
wherein said OTP memory comprises
a data memory area in which the substance of data is stored;
a file management information memory area in which storage information on a file stored in said data memory area is recorded; and
a modification data memory area which is a predetermined area in said data memory area, in which modification data is stored,
and wherein after a first file is recorded in said data memory area and storage information on said first file is recorded in said file management information memory area, when modification of said first file is needed, a second file in which modification information on said first file is recorded is additionally written into said modification data memory area,
said file system comprises modification means which reads out said first file and said second file by referring to said file management information memory area and said modification data memory area when said program issues an access request for said first file, for modifying said first file on the basis of said second file, and
said program accesses a file modified by said file system.

8. The information processing apparatus according to claim 7, wherein
said file system does not disclose information on said second file to said program.

9. The information processing apparatus according to claim 7, wherein
if said second file is a replacement file for said first file, said modification means does not modify said first file but replaces said first file with said second file.

10. A method of using an OTP (One Time Programmable) memory, wherein a first file to be modified is stored in said OTP memory, said method comprising:
a step of additionally writing a second file in which modification information on said first file is recorded into a data memory area of said OTP memory;
a step of additionally writing storage information on said second file into a file management information memory area of said OTP memory;
a step of referring to said file management information memory area to recognize the existence of said second file when a program issues an access request for said first file, and reading out said first file and said second file as well;
a modification step of modifying said first file on the basis of said second file which is read out; and
a step of allowing said program to access a modified file.

11. The method of using an OTP memory according to claim 10, wherein
if said second file is a replacement file for said first file, in said modification step, said first file is not modified but replaced with said second file.

12. A method of using an OTP (One Time Programmable) memory, wherein a first file to be modified is stored in said OTP memory, said method comprising:
a step of additionally writing a second file in which modification information on said first file is recorded into a data memory area of said OTP memory;
a step of additionally writing storage information on said second file into a modification information memory area which is reserved in said data memory area of said OTP memory;
a step of referring to said modification information memory area to recognize the existence of said second file when a program issues an access request for said first file, and reading out said first file and said second file as well;
a modification step of modifying said first file on the basis of said second file which is read out; and
a step of allowing said program to access a modified file.

13. The method of using an OTP memory according to claim 12, wherein
if said second file is a replacement file for said first file, in said modification step, said first file is not modified but replaced with said second file.

14. A method of using an OTP (One Time Programmable) memory, wherein a first file to be modified is stored in said OTP memory, said method comprising:
a step of additionally writing a second file in which modification information on said first file is recorded into a modification data memory area which is reserved in a data memory area of said OTP memory;
a step of referring to said modification data memory area to recognize the existence of said second file when a program issues an access request for said first file, and reading out said first file and said second file as well;
a modification step of modifying said first file on the basis of said second file which is read out; and
a step of allowing said program to access a modified file.

15. The method of using an OTP memory according to claim 14, wherein
if said second file is a replacement file for said first file, in said modification step, said first file is not modified but replaced with said second file.
